(19) United States
(12) Patent Application Publication
(10) Pub. No.: US 2023/0245498 A1
(43) Pub. Date: Aug. 3, 2023

(54) PREDICTIVE ACTION ASSISTANCE

(71) Applicant: ObjectVideo Labs, LLC, Tysons, VA (US)

(72) Inventors: Ethan Shayne, Clifton Park, NY (US); Donald Gerard Madden, Columbia, MD (US)

(21) Appl. No.: 18/101,919

(22) Filed: Jan. 26, 2023

Related U.S. Application Data
(60) Provisional application No. 63/304,745, filed on Jan. 31, 2022.

(51) Int. Cl. G06V 40/20; G06V 20/40; G06T 7/70; G06T 7/20

(52) U.S. Cl. CPC G06V 40/20; G06V 20/44; G06T 7/70; G06T 7/20; G06T 2207/30201

(57) ABSTRACT

Methods, systems, and apparatus, including computer programs encoded on computer storage media, for performing assistive actions using predictive human behavior. One of the methods includes obtaining a the first image of a person within a first threshold distance of a property; predicting, using the first image of the person, a task flow including a sequence of activities to be performed by the person; obtaining a second image of the person within a second threshold distance of the property; determining, using the second image, that activities performed by the person do not match the task flow; and in response to determining that the activities performed by the person do not match the predicted task flow, performing one or more actions at the property.

### CROSS-REFERENCE TO RELATED APPLICATION

This application claims the benefit of U.S. Provisional Application No. 63/304,745, filed Jan. 31, 2022, the contents of which are incorporated by reference herein.

### TECHNICAL FIELD

This disclosure application relates generally to using video analysis to track human task flows.

### BACKGROUND

Many properties are equipped with monitoring systems that include sensors and connected system components. Some monitoring systems include interactive devices and sensors such as cameras that are positioned to monitor human interaction with the devices.

A hardware design process for a device can involve a human-factor analysis stage, where people are observed using the device. This can be done in a controlled setting, and may involve millisecond-level-precision timers and/or cameras tracking activities such as eye movement. For devices that include an integrated camera, human activities can be monitored using the integrated camera.

### SUMMARY

Techniques are described for human task flow tracking and guidance. Many property owners equip their properties with monitoring systems to enhance the security, safety, or convenience of their properties. A property monitoring system can include cameras that can obtain visual images of scenes at the property. A camera can be positioned near an interactive device, such as a doorbell or appliance. In some examples, a camera can be incorporated into a device, such as a doorbell or appliance.

A doorbell can be activated to notify a resident of a property that a visitor has arrived. The resident can be notified, for example, by activation of a doorbell chime or by transmission of a notification to an electronic device associated with the resident. A doorbell can activated in various ways. For example, a touchless doorbell can activate a doorbell chime based on sensor data captured from sensors that are integrated with the doorbell or located near the doorbell. In some cases, a touchless doorbell can activate a doorbell chime based on video analysis of camera image data that indicates that a person is standing in an area of interest of the camera field of view. The area of interest can correspond to an area that is occupied by an object such as a doormat. In an example of a touch-button doorbell, the doorbell can include a button that causes activation of a doorbell chime and/or transmission of a notification when the button is pressed.

The disclosed techniques can be used to assist people with interacting with devices such as doorbells. For example, assistance can be provided to a visitor by illuminating a button of a touch-button doorbell. In another example, assistance can be provided to a visitor by instructing the visitor, through verbal or textual instructions, to stand on a doormat corresponding to an area of interest of a camera in order to activate the doorbell.

The disclosed techniques can be used to monitor actions, movements, behaviors, and activities of users they approach and interact with a device. Monitored actions can include, for example, head movement, eye movement, limb movement, lip movement, facial expressions, and other types of actions. The tracking and guidance system can monitor a user as the user performs activities such as approaching the device, looking at the device, reaching for buttons or switches on the device, looking around the area near the device, etc.

Using video analysis, a tracking and guidance system can determine whether a user's behavior indicates that the user likely needs or will need assistance. Based on determining that the user's behavior indicates that the user likely needs or will need assistance, the system can provide timely guidance to the user for interacting with the device. In some examples, the system can provide timely guidance to the user whether or not the user's behavior indicates that the user needs assistance.

Implementations of the present disclosure will be described in detail with reference to an example context. However, the implementations may be applicable more generally to any user-interactive device for which a camera is positioned to observe user interaction with the device. The example context includes a doorbell positioned near a door to a property. Implementations of the present disclosure can be realized in other appropriate contexts, for example, an automated teller machine, an automated ticketing kiosk, a retail self-checkout kiosk, a vending machine, a smart appliance, a fuel pumping machine, an electronic voting machine, and other contexts.

In general, one innovative aspect of the subject matter described in this specification can be embodied in methods that include the actions obtaining a first image of a person within a first threshold distance of a property; predicting, using the first image of the person, a task flow including a sequence of activities to be performed by the person; obtaining a second image of the person within a second threshold distance of the property; determining, using the second image, that activities performed by the person do not match the task flow; and in response to determining that the activities performed by the person do not match the predicted task flow, performing one or more actions at the property.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, predicting the task flow includes: determining, using one or more images of the person, that a person crossed a virtual line for the property; and in response to determining that the person crossed the virtual line for the property, predicting the task flow including the sequence of activities to be performed by the person.

In some implementations, predicting the task flow includes: determining, using one or more images of the person, whether a time period satisfies a time period threshold; and in response to determining that the time period satisfies the time period threshold, predicting the task flow including the sequence of activities to be performed by the person.

In some implementations, predicting the task flow includes: determining, using one or more images of the person, whether a time period after which the person completed a task satisfies a time period threshold; and in response to determining that the time period after which the person completed the task satisfies the time period threshold, predicting the task flow including the sequence of activities to be performed by the person.

In some implementations, predicting the task flow includes: determining, using one or more images of the person and an eye tracking process, an object at which the person is likely looking; and predicting, using data for the object at which the person is likely looking, the task flow including the sequence of activities to be performed by the person.

In some implementations, predicting the task flow includes: determining, using one or more images of the person, one or more tasks performed at least a threshold amount by the person; and selecting, from the one or more tasks performed at least the threshold amount by the person, a most likely task flow for the person.

In some implementations, predicting the task flow includes: determining, using one or more images of the person, a predicted visit type for the person; and selecting, from a database that includes data for a plurality tasks and using the predicted visit type for the person, a most likely task flow for the person.

In some implementations, predicting the task flow includes: determining, using one or more images of the person and one or more inputs, one or more tasks performed at least a threshold amount by the person; and selecting, from the one or more tasks performed at least the threshold amount by the person, a most likely task flow for the person.

In some implementations, predicting the task flow includes: determining, using one or more images of the person and sensor data from the property, one or more tasks performed at least a threshold amount by the person; and selecting, from the one or more tasks performed at least a threshold amount by the person, a most likely task flow for the person.

In some implementations, performing the one or more actions at the property includes providing, to a signaling device physically located at the property, an instruction to cause the signaling device to present an alert to the person about at least one activity from the sequence of activities for the task flow.

The subject matter described in this specification can be implemented in various implementations and may result in one or more of the following advantages. In some implementations, the systems and methods described in this specification can aid users in performing tasks, interacting with systems, or understanding the environment. For example, aiding a user in finding the doorbell by illuminating the front porch and doorbell. In some implementations, the systems and methods described in this specification can reduce computer resource usage by helping a person complete a task more quickly or determining an event is not worth recording, e.g., reducing the resources necessary to monitor the person. In some implementations, the systems and methods described in this specification can alert users of activity that is unexpected. In some implementations, the systems and methods described in this specification can provide feedback to manufacturers on how products are being interacted with. For instance, one might find that people are having trouble finding the doorbell button and thus change the color of the lighting used to illuminate it. In one example, the system might be used to A/B test features such as illumination on doorbells. Some doorbells might be configured to have steady illumination and others with blinking illumination, and the system could collect data to determine which style led to lower average times for interaction.

The details of one or more implementations of the subject matter described in this specification are set forth in the accompanying drawings and the description below. Other features, aspects, and advantages of the subject matter will become apparent from the description and the drawings.

### BRIEF DESCRIPTION OF THE DRAWINGS

FIG. 1 illustrates an example system for human task flow tracking and guidance using a camera.

FIG. 2 is a flow chart illustrating an example of a process for human task flow tracking and guidance.

FIG. 3 is a diagram illustrating an example of a monitoring system.

Like reference numbers and designations in the various drawings indicate like elements.

### DETAILED DESCRIPTION

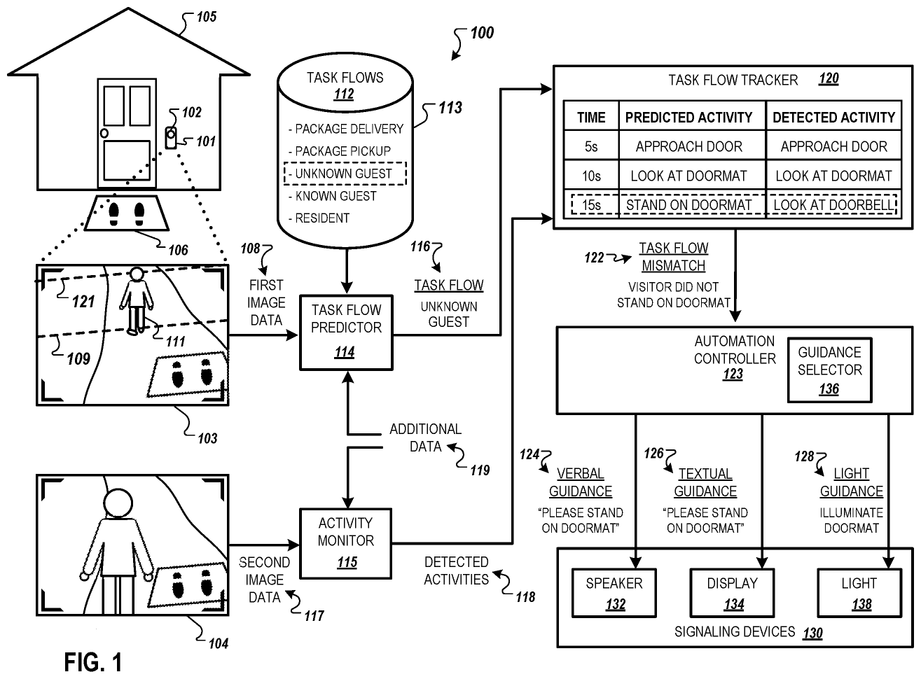

FIG. 1 illustrates an example system 100 for human task flow tracking and guidance using a camera. In FIG. 1, a camera 102 is installed at a property 105. The property 105 can be a home, another residence, a place of business, a public space, or another facility that has one or more cameras 102 installed. In the example of FIG. 1, the camera 102 is a component of a doorbell 101 that is installed external to the property 105. The doorbell 101 is installed near a door 107 of the property 105. A doormat 106 is positioned near the door 107.

In some examples, the doormat 106 is positioned within a field of view of the camera 102. The area of the field of view that is occupied by doormat 106 can be labeled as an area of interest. In some examples, the doorbell 101 is a touchless doorbell and is configured to activate an audible chime at the property 105 in response to the camera 102 detecting a person entering the area of interest, e.g., by stepping on the doormat 106.

In some examples, the doorbell 101 is a button-press doorbell and is configured to activate an audible chime at the property 105 in response to a person pressing a button of the doorbell 101. In addition to, or instead of, activating a doorbell chime, the doorbell 101 can be configured to perform other actions, such as transmitting a notification to a user device associated with a resident of the property 105. In some examples, the doorbell 101 is a component of a monitoring system that collects data from various sensors to monitor conditions and events at the property 105.

Although various examples describe a resident of the property 105, these examples can apply to other types of occupants for the property 105. For instance, the examples can generally apply to an employee of the property 105 as another type of occupant.

In addition to the camera 102, the doorbell 101 may include other components and sensors. For example, the doorbell 101 may include a button that, when depressed, causes an audible tone to sound at the property 105. The doorbell 101 may also include additional sensors, e.g., a motion sensor, temperature sensor, light sensor, and a microphone.

The camera 102 captures video from a scene within a field of view. The video includes multiple sequential images, or frames. The video can include any type of images. For example, the video can include visual light images, infrared images, or radio wave images. In some examples, the video can include a combination of one or more types of images, e.g., visual light images with infrared illumination.

The field of view is an area that is observable by the camera 102. The camera 102 has a field of view that includes the area in front of the property 105. For example, the field of view can include a walkway leading to the door 107. In some examples, the camera 102 can capture video continuously. In some examples, the camera 102 can capture video when triggered by an event. For example, the camera 102 may capture video when triggered by depression of the button on the doorbell 101. In some examples, the camera 102 may capture video when triggered by activation of the motion sensor or other sensor of the doorbell 101.

The camera 102 may capture video for a preprogrammed amount of time. For example, when triggered by depression of the button on the doorbell 101, the camera 102 may capture video for a preprogrammed time of 10 seconds, 30 seconds, or 60 seconds. When triggered by a motion sensor, the camera 102 may capture video for a preprogrammed time and/or may capture video until the motion sensor no longer detects motion.

The camera 102 can perform video analysis on captured video. Video analysis can include detecting, identifying, and tracking objects, or targets, in the video. In some examples, the camera 102 can use video analysis to detect the presence of a human within a frame. In some examples, the camera 102 can use video analysis to detect actions performed by the human. For example, video analysis can be performed to track limb movement, to track eye movement, to track a direction in which the human is gazing, to identify gestures made by the human, or any of these. The camera 102 can also use video analysis to perform facial recognition, to perform object recognition, to identify facial expressions of the human, or any of these.

The system 100 includes components including a task flow database 113, a task flow predictor 114, an activity monitor 115, a task flow tracker 120, automation controls 123, and signaling devices 130. In some examples, the components of the system 100 can be implemented by a computing system including one or more computing devices such as the camera 102, a monitoring server of a property monitoring system, or a monitor control unit of a property monitoring system. In some examples, the components of the system 100 can be provided as one or more computer executable software modules or hardware modules. That is, some or all of the functions of the components can be provided as a block of computer code, which upon execution by a processor, causes the processor to perform functions described below. Some or all of the functions of the components can be implemented in electronic circuitry, e.g., by individual computer systems (e.g., servers), processors, microcontrollers, a field programmable gate array (FPGA), or an application specific integrated circuit (ASIC).

In the example of FIG. 1, a visitor 111 approaches the door 107 of the property 105. The camera 102 captures video that includes a first image 103. The camera 102 outputs first image data 108 representing the first image 103 to the task flow predictor 114. The camera 102 may capture the video including the first image 103, for example, upon one or more of being triggered by a motion sensor that detects the motion of the visitor 111 or as part of a constant capturing of frames.

In some examples, the camera 102 outputs the first image data 108 to the task flow predictor 114 in response to detecting a person crossing virtual line crossing 121. The virtual line crossing 121 can be positioned at a location where a visitor is likely to come from when approaching the property 105. For example, the virtual line crossing 121 can be positioned at or near a location where a walkway to the property 105 intersects with a sidewalk or roadway. Thus, a person crossing the virtual line crossing 121 is likely to be a visitor to the property, instead of a passerby.

The first image 103 includes a depiction of the visitor 111 approaching the doormat 106. The task flow predictor 114 receives first image data 108 representing the first image 103. The task flow database 113 includes data defining task flows 112. Each task flow 112 of the task flow database 113 can be associated with a label, e.g., “package delivery” or “resident.” Each task flow 112 can include metadata specifying detected objects or actions that are associated with the task flow.

The task flow predictor 114 can select a task flow 112 from the task flow database 113 based on the first image data 108. The task flow 112 can include a script of tasks that the visitor 111 is expected to perform while in the field of view of the camera 102. Based on video analytics and/or additional data, the task flow predictor 114 can select a task flow 112 that most closely matches the tasks that the visitor 111 is predicted to perform.

In some examples, a task flow 112 can include a series of tasks expected to be performed by the visitor 111, as well as a series of automated actions expected to occur. For example, a task flow 112 associated with a resident of the property 105 can include the resident approaching the door 107, the resident standing on the doormat 106, the automation controller 123 unlocking an automatic lock of the door 107, the automation controller 123 broadcasting a “welcome home” message through the speaker 132, and the resident reaching for a doorknob of the door 107. Thus, the task flow 112 labeled “resident” can include both visitor actions and automated system actions. In some examples, the automated system actions of the task flow are expected to occur in response to visitor actions. For example, the task flow labeled “resident” can include the automation controller 123 unlocking the automatic lock of the door 107 in response to the camera 102 detecting the resident standing on the doormat 106.

Although shown in FIG. 1 as representing a single image (first image 103), in some examples the first image data 108 can represent multiple images. For example, the first image data 108 can represent a series of images that are analyzes by the task flow predictor 114 in order to select a task flow 112. In some examples, the series of images can include a specified number of images, e.g., thirty images, or a number of images captured over a specified period of time, e.g., 0.5 seconds. In some examples, the series of images can include images that are captured before an event occurs, e.g., images that are captured before the task flow predictor 114 selects a task flow 112, or images that are captured before the visitor 111 crosses a virtual line crossing 109.

In some examples, the task flow predictor 114 selects a task flow 112 based on identifying the visitor 111. The task flow predictor 114 can identify the visitor using video analysis, e.g., facial recognition, text recognition, and/or object recognition. For example, the visitor 111 may have a face that is recognizable to the camera 102 and/or may be wearing clothing or accessories that aid in identification, e.g., a nametag, an identification badge, etc. For example, the task flow predictor 114 can identify the visitor 111 as a resident of the property 105. In some examples, the task flow predictor 114 can identify the visitor 111 as a regular guest of the property 105.

In an example, the task flow predictor 114 can identify the visitor 111 as a resident of the property 105 and select a task flow 112 based on identifying the visitor 111 as a resident of the property 105. The task flow for a resident can include, for example, approaching the door 107, reaching for the doorknob of the door 107, opening the door 107, and entering the property 105 through the door 107.

In another example, the task flow predictor 114 can identify the visitor 111 as a known guest of the property 105 and select a task flow 112 based on identifying the visitor 111 as a known guest of the property 105. The task flow 112 for a known guest can include, for example, approaching the door 107, looking at the doormat 106, and standing on the doormat 106.

In some examples, the task flow predictor 114 selects a task flow 112 based on classifying the visitor 111. The task flow predictor 114 can classify the visitor 111 using video analysis, e.g., object recognition. For example, the visitor 111 may be wearing or carrying objects that aid in classification, e.g., a uniform, a package, a dog leash, a toolbox, a ladder, etc. The task flow predictor 114 can classify the visitor 111 or visit type as a person providing a service, e.g., a package delivery person, a package pickup person, a maintenance person, a dog walker, etc., based on detected objects that are worn or carried by the visitor 111.

In an example, the visitor 111 may be wearing a uniform of a delivery person. The task flow labeled “package delivery” may include metadata indicating that the uniform is associated with the task flow. Therefore, based on detecting the visitor 111 wearing the uniform, the task flow predictor 114 can classify the visitor 111 and/or visit type as a delivery person and select the task flow 112 labeled “delivery person.” The task flow 112 for a delivery person can include, for example, approaching the door 107, placing a package on or near the doormat 106, and departing from the property 105.

In another example, the task flow predictor 114 can classify the visitor 111 as a dog walker and select a task flow 112 based on identifying the visitor 111 as a dog walker. The task flow 112 for a delivery person can include, for example, approaching the door 107, entering an access code to a keypad, opening the door 107, and entering the property 105 through the door 107.

In some examples, the task flow predictor 114 can identify and/or classify the visitor 111 based on additional data input. In some examples, the visitor 111 can enter a code to a keypad and/or can swipe an access card or key fob at the door 107. The task flow predictor 114 can identify and/or classify the visitor 111 based on data from the code, card, or fob.

In some examples, the task flow predictor 114 can perform a narrowing process to select the task flow 112 from multiple candidate task flows of the task flow database 113. For example, upon detecting the visitor 111 in the first image 103, the task flow predictor 114 may determine, using video analysis, that the visitor 111 is not carrying a package. Based on determining that the visitor 111 is not carrying a package, the task flow predictor 114 can eliminate the candidate task flow of “package delivery” from consideration. The task flow predictor 114 may also determine using video analysis that no package is awaiting pickup in the field of view of the camera 102. Based on determining that no package is awaiting pickup, the task flow predictor 114 can eliminate the candidate task flow of “package pickup” from consideration.

As the visitor 111 approaches the camera 102, the task flow predictor 114 can determine, using video analysis, whether the visitor 111 is a recognized or unrecognized person. In the example of FIG. 1, based on determining that the visitor 111 is an unrecognized person, the task flow predictor 114 can eliminate from consideration the candidate task flows labeled “resident” and “known guest.” Therefore, the task flow predictor 114 can select a particular task flow 116 labeled “unknown guest.”

In some examples, the task flow predictor 114 can determine a probability that the visitor 111 will perform each task flow of the task flow database 113. For example, upon detecting the visitor 111 in the first image, the task flow predictor 114 can determine an initial probability that the visitor 111 is performing each of the task flows. The task flow predictor 114 can update the probabilities for each task flow 112 over time.

In an example, the task flow predictor 114 may determine initial probabilities of five percent for the task flow labeled “package delivery,” ten percent for the task flow labeled “package pickup,” forty percent for the task flow labeled “unknown guest,” twenty-five percent for the task flow labeled “known guest,” and twenty percent for the task flow labeled “resident.” As the visitor 11 approaches the camera 102, the task flow predictor 114 can determine updated probabilities of two percent for the task flow of “package delivery,” ten percent for the task flow labeled “package pickup,” sixty percent for the task flow labeled “unknown guest,” twenty percent for the task flow labeled “known guest,” and eight percent for the task flow labeled “resident.”

In some examples, the task flow predictor 114 can select a task flow 112 based on the probability for the task flow exceeding a threshold probability. For example, the task flow predictor 114 can select a task flow 112 based on determining that the task flow 112 exceeds a threshold probability of fifty percent.

In some examples, the task flow predictor 114 can select the task flow 112 having the highest probability at a certain time. For example, the task flow predictor 114 can evaluate the first image data 108 using a virtual line crossing 109. The virtual line crossing can be a boundary in the field of view of the camera 102 that is positioned such that the visitor 111 will likely cross the virtual line crossing 109 while approaching the camera 102. The task flow predictor 114 can determine a time that the visitor 111 crosses the virtual line crossing 109, and select the task flow 112 having the highest probability at the time that the visitor 111 crosses the virtual line crossing 109.

In some examples, the task flow predictor 114 can select a task flow 112 based at least in part on additional data 119. Additional data 119 can include, for example, weather data, data indicating a time of day, data indicating a day of week, data indicating a season of year, etc. For example, the task flow predictor 114 may determine a higher likelihood during the day that the visitor 111 is delivering a package, compared to at night. Similarly, the task flow predictor 114 may determine a higher likelihood on a weekday that the visitor 111 is delivering a package, compared to on a weekend. In another example, the task flow predictor 114 may determine a higher likelihood at the end of a work day that the visitor 111 is a resident, compared to the middle of the work day.

In some examples, the additional data can include sensor data generated by sensors at the property 105. For example, the sensors can include touch sensors, time-of-flight (TOF) sensors, other cameras, motion sensors, pressure sensors, etc. In some examples, the sensors can be integrated with the camera 102, with the doorbell 101, or both. For example, a motion sensor and the camera 102 can be integrated into the doorbell 101. In some examples, a touch sensor can be integrated into the doorbell 101, e.g., into a button of the doorbell 101. In some examples, the sensors can be separate from the camera 102, the doorbell 101, or both. For example, a pressure sensor can be positioned under the doormat 106.

The task flow predictor 114 can select the task flow 112 based at least in part on sensor data. For example, sensor data from a pressure sensor may indicate the presence of a package on the doormat 106. The task flow predictor 114 can determine a higher likelihood when a package is on the doormat 106 that the visitor 111 is picking up a package, compared to when no package is on the doormat 106.

In some examples, the task flow predictor 114 can select the task flow 112 based at least in part on historical data. For example, camera 102 can store data representing visitors who have approached the property 105 over time. The camera 102 can analyze the historical data to identify patterns, and select appropriate task flows based on the patterns. For example, the task flow predictor 114 may determine a pattern that every weekday at approximately 12:00 pm, a dog walker approaches the property 105, enters a code into a keypad, enters the property 105 through the door 107, and then departs from the property 105 through the door 107 with a dog. The pattern can also include the dog walker and the dog returning to the property 105 at approximately 12:30 pm. Based on the observed patterns, the task flow database 113 can store a “dog walker arriving” task flow representing tasks of the dog walker upon arrival, and a “dog walker returning” task flow representing tasks of the dog walker upon returning with the dog. The task flow predictor 114 can determine, based on the historical data, a high probability that a visitor approaching the property 105 at approximately 12:00 pm on a weekday is a dog walker, and thus select the task flow “dog walker arriving.” Additionally, the task flow predictor 114 can determine, based on the historical data, a high probability that a visitor approaching the property 105 at approximately 12:30 pm on a weekday is the dog walker, and thus select the task flow “dog walker returning.”

The camera 102 continues to capture subsequent frames, including a second image 104. The second image 104 includes a depiction of the visitor 111. The visitor 111 approaches the door 107, such that the visitor 111 is nearer to the camera 102 in the second image 104 than in the first image 103.

The activity monitor 115 receives second image data 117 representing the second image 104. The activity monitor 115 can also receive additional data 119, e.g., sensor data or additional camera data. Based on the second image data 117, the additional data 119, or both, the activity monitor 115 can monitor activities of the visitor 111. Activities can include, for example, walking towards the camera 102, walking away from the camera 102, looking at the camera 102, looking at the doormat 106, reaching towards the camera 102, etc. The activity monitor outputs data indicating detected activities 118 to the task flow tracker 120. The output detected activities can include timestamps of each detected activity.

In the example of FIG. 1, the activity monitor 115 outputs detected activities 118 of the visitor 111 to the task flow tracker 120. The detected activities 118 include approaching the door 107, looking at the doormat 106, and looking at the doorbell 101. The visitor 111 walks past the doormat 106.

The task flow tracker 120 compares the detected activities 118 to the predicted activities of the particular task flow 116. The particular task flow 116 for an unknown guest includes approaching the door (e.g., by crossing virtual line crossing 109), looking at the doormat 106, and standing on the doormat 106. The particular task flow 116 can include expected times for each task. For the example of FIG. 1, the expected time for approaching the door 107 is five seconds, the expected time for looking at the doormat 106 is ten seconds, and the expected time for standing on the doormat 106 is fifteen seconds.

Although described as being measured in seconds, in some examples the activity monitor 115 and/or task flow tracker 120 use millisecond-level-precision timers to track rapid movements, such as eye movement of the visitor. The precision timers can be used to provide timely guidance to the visitor 111. For example, the task flow tracker 120 can use eye tracking to determine that the visitor 111 is not looking towards the doormat 106 as the user approaches the doormat 106, and the automation controller 123 can activate the signaling devices 130 before the visitor 111 passes by the doormat 106.

In some examples, a time for a predicted or detected activity can be measured from a start time. For example, for a task flow that includes two predicted activities, the first predicted activities may be expected at three seconds after the start time, and the second predicted activities may be expected at six second after the start time.

In some examples, the start time is a time when the visitor 111 crosses a virtual line crossing, e.g., virtual line crossing 121. In some examples, the start time can be a time when the depiction of the visitor 111 is first captured by the camera 102, or a time when the camera 102 first classifies the visitor 111 as a human.

In some examples, a time for a predicted or detected activity can be measured from a time of accomplishing a previous task of the task flow. For example, for a task flow that includes two predicted activities, the first predicted activity may be expected at three seconds after the start time, and the second predicted activity may be expected at three seconds after completion of the first predicted activity.

The expected times of each task flow can be based on historical data. In some examples, the camera 102 can obtain historical data from visitors to the property 105, from other properties, or both. The historical data from other properties can include aggregated, anonymous data. In some examples, the camera 102 can analyze historical data to determine average times for accomplishing each task of the task flow. In some examples, each task of the task flow is associated with an average expected time, a minimum expected time, and/or a maximum expected time.

In some examples, the task flow times can vary depending on identifying the visitor 111. For example, the task flow for a known guest and the task flow for an unknown guest may include the same steps, e.g., of approaching the door 107, looking at the doormat 106, and standing on the doormat 106. However, the task flow times for a known guest may be faster than the task flow times for an unknown guest. As an example, the expected time for standing on the doormat 106 for an unknown guest can be fifteen seconds, while the expected time for standing on the doormat 106 for a known guest can be a shorter amount of time, e.g., twelve seconds.

Each task of the task flow can also be associated with a trigger time, where the monitoring system is configured to prompt the visitor to perform the task at the trigger time. In some examples, the trigger time can be the same as the average time or can be the same as the maximum expected time. In some examples, the trigger time can be a time between the average expected time and the maximum expected time. In some examples, the trigger time can be a time after the maximum expected time, e.g., a time that is one second after the maximum expected time, or a time that is ten percent longer than the maximum expected time.

In the example of FIG. 1, the expected time for standing on the doormat 106 is fifteen seconds. The maximum expected time may be, e.g., seventeen seconds. The trigger time can be, e.g., fifteen seconds, sixteen seconds, seventeen seconds, or a time greater than seventeen seconds. At the trigger time, if the visitor 111 based on determining that the visitor 111 has not stood on the doormat 106, the task flow tracker 120 can output a task flow mismatch 122 to an automation controller 123. The task flow mismatch 122 indicates that the visitor 111 has not followed the expected task flow.

In the example of FIG. 1, the task flow mismatch 122 indicates that the visitor 111 did not stand on the doormat at the expected time of fifteen seconds. The automation controller 123 can perform automation control actions based on guidance selected by a guidance selector 136. In some examples, the guidance selector 136 stores data indicating, for each of various tasks, one or more actions to be performed to guide the visitor 111 to perform the task. For example, the guidance selector 136 can store data indicating, for the task of standing on the doormat, actions that can be performed to guide the visitor 111 to perform the task.

In some examples, the actions stored by the guidance selector 136 can include multiple actions. For example, for the task of standing on the doormat 106, the guidance selector 136 can store data indicating actions of illuminating the doormat 106, e.g., using a light that is integrated with the camera 102 or located near the camera 102. The guidance selector 136 can also store data indicating actions of displaying text on a display that reads “Please stand on doormat,” and actions of broadcasting verbal guidance through a speaker that says “Please stand on doormat.” In some examples, the guidance selector 136 can include a sequence of actions. For example, the sequence of actions can include firstly illuminating the doormat, secondly displaying the text, and thirdly broadcasting the verbal guidance.

In some examples, the sequence of actions can be stored with associated times that indicate when the actions should be automatically performed. For example, the sequence of actions can include illuminating the doormat at one second after the trigger time, displaying the text at two seconds after the trigger time, and broadcasting the verbal guidance at three seconds after the trigger time. In some examples, the sequence can include conditional actions based on detected actions. For example, the sequence can include illuminating the doormat, and if the visitor 111 does not stand on the doormat after two seconds, then displaying the text guidance.

The automation controller 123 performs automation control of signaling devices 130 based on the guidance selected by the guidance selector 136. For example, for the task flow mismatch of the visitor 111 not standing on the doormat 106, the guidance selector can select a series of actions to guide the visitor 111 to stand on the doormat 106, and the automation controller 123 can transmit commands to signaling devices 130 to perform the series of actions. The signaling devices 130 include, e.g., a speaker 132, a display 134, and a light 138.

In the example of FIG. 1, the automation controller 123 outputs a verbal guidance command 124 to the speaker 132. The verbal guidance command 124 instructs the speaker 132 to broadcast “Please stand on the doormat.” The automation controller 123 outputs a textual guidance command 126 to the display 134. The textual guidance command 126 instructs the display to display “Please stand on the doormat 106.” The automation controller 123 outputs a light guidance command 128 to the light 138. The light guidance command 128 instructs the light to illuminate the doormat 106.

The activity monitor 115 can continue to receive subsequent frames and can monitor human activity in each frame. In some examples, the activity monitor 115 can continue to monitor activities of the visitor 111 until the visitor 111 no longer appears in the field of view.

Though the example of FIG. 1 shows a task flow for a touchless doorbell, other implementations are possible. For example, the processes described with reference to FIG. 1 can be applied to other types of doorbells, e.g., touch-button doorbells. The processes described with reference to FIG. 1 can also be applied to any interactive device that includes an integrated camera and/or is located near an integrated camera that captures images of a user.

In some examples, the processes of FIG. 1 can be used to monitor small movements and actions performed by a user. For example, the activity monitor 115 can monitor head movement, eye movement, or both of the visitor 111. For example, the activity monitor 115 can determine, based on head and/or eye movement, that the visitor 111 represented in the second images data 117 is looking around, e.g., by looking at each of the door 107, the doorbell 101, and the doormat 106. Based on determining that the visitor 111 is looking around, the task flow tracker 120 can determine that the visitor 111 needs guidance. In the example of a button-press doorbell, the automation controller 123 can control signaling devices to provide guidance, e.g., by illuminating the button or to blinking a light at the location of the button. In some examples, the light can be a back light of the button. In some examples, the light can be positioned such that, when activated, the light shines on the button to illuminate the button. The automation controller 123 can also control signaling devices to provide guidance, e.g., by providing verbal guidance through a speaker and/or by presenting textual guidance on a display.

In some examples, the task flow tracker 120 can store data indicating a position of the doorbell button relative to the position of the camera. For example, the doorbell button may be positioned slightly below the camera lens. The activity monitor 115 can track movement of the visitor's eyes, and the task flow tracker 120 can determine whether the movement of the visitor's eyes indicates that the visitor 111 is looking at the doorbell button.

In some examples, the activity monitor 115 can track movement of limbs of the visitor 111, e.g., to determine whether the visitor reaches for the doorbell 101. In some examples, the visitor 111 may reach to press the lens of the camera 102 instead of the doorbell button that is located below the lens. The task flow tracker 120 can track the trajectory of the visitor's hands and fingers, and may determine that the visitor 111 is reaching to touch the lens. Based on determining that the visitor 111 is reaching to touch lens of the camera 102, the task flow tracker 120 can determine that the visitor 111 needs guidance. The automation controller 123 can provide guidance, e.g., by using signaling devices to illuminate the button, blink a light at the location of the button, provide verbal guidance, and/or provide textual guidance instructing the visitor 111 to touch the doorbell button below the lens.

In an example, the task flow tracker 120 may detect that a visitor has approached the front porch, is looking at the doorbell device, but has not pressed the doorbell button within a threshold amount of time, e.g., 250 ms. The automation controller 123 can provide guidance to the visitor 111, e.g., by blinking a light embedded in the doorbell button. If the visitor still remains on the porch but has not pressed the button after an additional threshold amount of time, e.g., 750 ms, the automation controller 123 can provide guidance to the visitor 111, e.g., by broadcasting verbal guidance through the speaker 132.

In some examples, automated assistance actions and timelines can be refined over time based on trends and patterns of visitor actions. The patterns can be identified for individual properties and/or based on aggregated data from multiple properties. In an example, the activity monitor 115 can observe visitor actions when the doorbell button is illuminated with a red light. The activity monitor 115 can also observe visitor actions when the doorbell button is illuminated with a blue light. The task flow tracker 120 can determine, based on historical patterns, that an average time between illumination of the doorbell button and the visitor pressing the doorbell button is shorter when the light is red than when the light is blue. Thus, the task flow tracker 120 can determine that visitors respond more quickly to red light compared to blue light. Based on the determination, the automation controller 123 can select to illuminate the doorbell button in red light instead of blue light.

In some examples, the activity monitor 115 can observe actions of different individual visitors and/or of classifications of visitors. For example, the activity monitor 115 can determine that visitors classified as known guests typically do not need assistance to find the doorbell button, while visitors classified as unknown guests do typically need assistance. Thus, the automation controller 123 can determine to wait a longer period of time before providing guidance to a known guest compared to an unknown guest.

In some examples, the task flow predictor 114 can classify the visitor 111 as having a hearing impairment, a visual impairment, a mobility impairment, or any of these. For example, the task flow predictor 114 can detect, using video analysis, a wheelchair, cane, and/or other assistance device. Based on detecting the assistance device, the task flow predictor 114 can select an appropriate task flow, and the automation controller 123 can select appropriate guidance actions. The task flow database 113 can store task flows 112 for various detected objects and/or impairments. For example, the task flow database 113 can store task flows 112 labeled “visual impairment,” “hearing impairment,” and “mobility impairment.” Each task flow 112 can include metadata specifying detected objects or actions that are associated with the task flow.

In an example, the task flow 112 for “mobility impairment” can include metadata indicating that the task flow is associated with detected mobility assistance objects such as crutches or a wheelchair. Based on detecting an assistance object such as a wheelchair, the task flow predictor 114 can therefore select the task flow 112 labeled “mobility impairment” from the task flow database 113. The task flow 112 for “mobility impairment” can include, for example, the visitor approaching the door within a specified threshold range to the door 107, and based on the visitor approaching within the specified threshold range to the door 107, the automation controller 123 providing verbal guidance to the visitor through the speaker 132. The verbal guidance can include, for example, directional guidance to direct the visitor to a wheelchair ramp.

In an example, using video analysis, the task flow predictor 114 may classify the visitor as having a visual impairment. For example, the task flow predictor 114 may detect a white cane in the first image data 108. The task flow predictor 114 can select an appropriate task flow from the task flow database 113, e.g., a task flow that is labeled “visual impairment.” The task flow labeled “visual impairment” can include metadata indicating that the task flow is associated with actions such as walking with a white cane. In some examples, based on the selected task flow for visually impaired guests, the task flow tracker 120 can output a command to the automation controller 123 to perform an action without waiting for a task flow mismatch. For example, the task flow tracker 120 can instruct the automation controller 123 to automatically activate a doorbell chime, and/or to provide verbal guidance to the visitor when the visitor is detected within a specified threshold distance to the door 107.

In some examples, the task flow predictor 114 can classify the visitor 111 as an unwanted guest. For example, a resident of the property may provide input identifying unwanted guests. The input can include, for example, an image of an unwanted guest, an image of a uniform worn by an unwanted guest, a description of a uniform worn by an unwanted guest, etc. In some examples, after a visit by an unwanted guest whose image is captured by the camera 102, the resident can provide input data labeling the image as an unwanted guest.

Based on the task flow predictor 114 classifying the visitor 111 as an unwanted guest, the task flow tracker 120 can output a command to the automation controller 123 to disable some or all of the signaling devices 130. In some examples, the task flow tracker 120 can instruct the automation controller 123 to disable devices such as the doorbell chime or a keypad for unlocking the door 107. In this way, the task flow tracker 120 can select not to assist the unwanted guest with entering the property 105, or to perform actions to prevent access of the unwanted guest to the property 105.

The system 100 is an example of a system implemented as computer programs on one or more computers in one or more locations, in which the systems, components, and techniques described in this specification are implemented. The system 100 can use a single server computer or multiple server computers operating in conjunction with one another, including, for example, a set of remote computers deployed as a cloud computing service.

The system 100 can include several different functional components, including an task flow predictor 114, an activity monitor 115, an automation controller 123, signaling devices 130, task flow tracker 120, and more. The task flow predictor 114, an activity monitor 115, an automation controller 123, signaling devices 130, or task flow tracker 120, or a combination of these, can include one or more data processing apparatuses, can be implemented in code, or a combination of both. For instance, each of the task flow predictor 114, an activity monitor 115, an automation controller 123, signaling devices 130, and task flow tracker 120 can include one or more data processors and instructions that cause the one or more data processors to perform the operations discussed herein.

The various functional components of the system 100 can be installed on one or more computers as separate functional components or as different modules of a same functional component. For example, the components task flow predictor 114, an activity monitor 115, an automation controller 123, signaling devices 130, and task flow tracker 120 of the system 100 can be implemented as computer programs installed on one or more computers in one or more locations that are coupled to each through a network. In cloud-based systems for example, these components can be implemented by individual computing nodes of a distributed computing system.

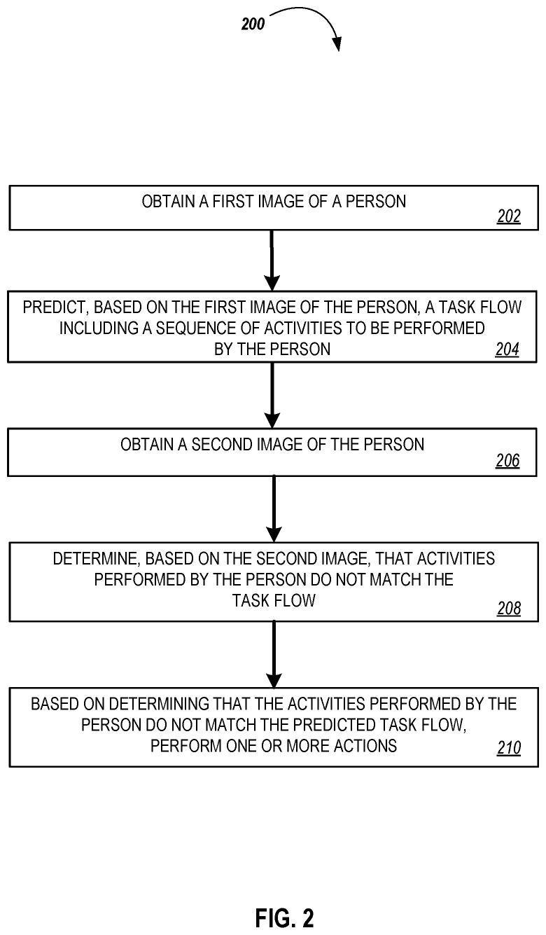

FIG. 2 is a flow chart illustrating an example of a process 200 for human task flow tracking and guidance. The process 200 can be performed by a camera, e.g. the camera 102. In some implementations, the process 200 can be performed by one or more computer systems that communicate electronically with a camera, e.g., over a network.

Briefly, process 200 includes obtaining a the first image of a person (202), predicting, based on the first image of the person, a task flow including a sequence of activities to be performed by the person (204), obtaining a second image of the person (206), determining, based on the second image, that activities performed by the person do not match the task flow (208), and based on determining that the activities performed by the person do not match the predicted task flow, performing one or more actions (210).

In additional detail, the process 200 includes obtaining a first image of a person (202). The camera can be, for example, the camera 102. The first image can be, for example, the first image 103. The first image may include depictions of one or more humans e.g., the visitor 111.

The process 200 includes predicting, based on the first image of the person, a task flow including a sequence of activities to be performed by the person (204). For example, the task flow predictor 114 can predict the particular task flow 116 based on the first image 103. The particular task flow 116 includes predicted activities of an unknown guest.

The process 200 includes obtaining a second image of the person (206). The second image can be, for example, second image 104. The second image 104 may include one or more of the same humans, e.g., the visitor 111, as the first image 103.

The process 200 includes determining, based on the second image, that activities performed by the person do not match the task flow (208). For example, the task flow tracker 120 can determine, based on the second image 104, that detected activities 118 performed by the visitor 111 do not match predicted activities of the particular task flow 116.

The process 200 includes based on determining that the activities performed by the person do not match the predicted task flow, performing one or more actions (210). For example, based on the task flow tracker 120 detecting a task flow mismatch 122, the automation controller 123 can perform actions including providing guidance to the visitor 111.

The order of steps in the process 200 described above is illustrative only, and can be performed in different orders. For example, the obtaining a first image of a person (202) and obtaining a second image of the person (206) can be performed before predicting, based on the first image of the person, a task flow including a sequence of activities to be performed by the person (204).

In some implementations, the process 200 can include additional steps, fewer steps, or some of the steps can be divided into multiple steps. For example, the process 200 can perform without steps obtaining a second image of the person (206) and determining, based on the second image, that activities performed by the person do not match the task flow (208). The process 200 can include the use of sensor data in addition to images. In some examples, the process 200 can include steps 206 through 210 without the other steps in the process 200.

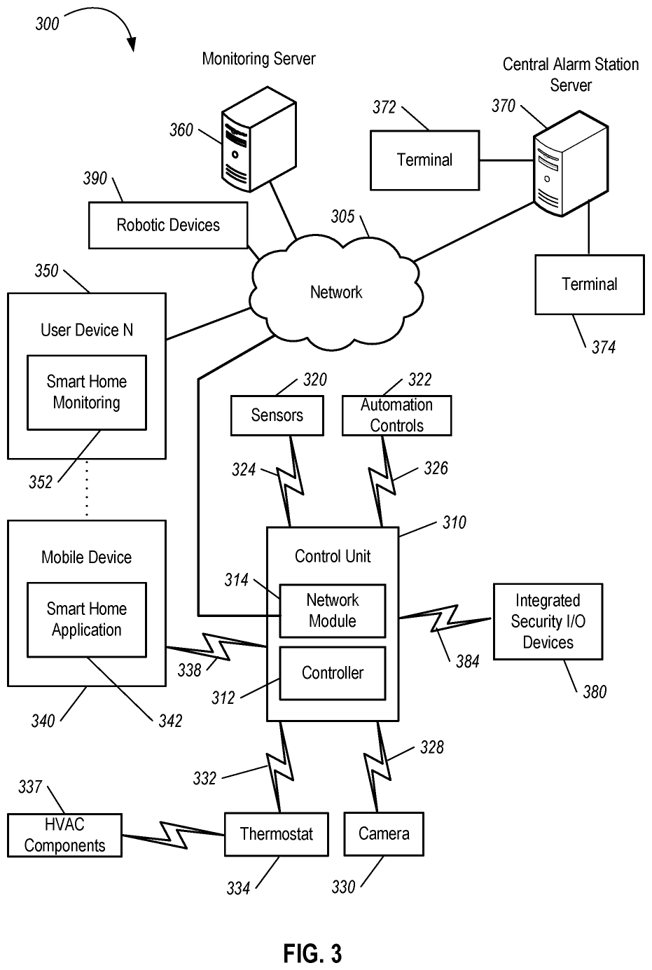

FIG. 3 is a diagram illustrating an example of a home monitoring system 300. The monitoring system 300 includes a network 305, a control unit 310, one or more user devices 340 and 350, a monitoring server 360, and a central alarm station server 370. In some examples, the network 305 facilitates communications between the control unit 310, the one or more user devices 340 and 350, the monitoring server 360, and the central alarm station server 370.

The network 305 is configured to enable exchange of electronic communications between devices connected to the network 305. For example, the network 305 may be configured to enable exchange of electronic communications between the control unit 310, the one or more user devices 340 and 350, the monitoring server 360, and the central alarm station server 370. The network 305 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other delivery or tunneling mechanism for carrying data. Network 305 may include multiple networks or subnetworks, each of which may include, for example, a wired or wireless data pathway. The network 305 may include a circuit-switched network, a packet-switched data network, or any other network able to carry electronic communications (e.g., data or voice communications). For example, the network 305 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice communications. The network 305 may include one or more networks that include wireless data channels and wireless voice channels. The network 305 may be a wireless network, a broadband network, or a combination of networks including a wireless network and a broadband network.

The control unit 310 includes a controller 312 and a network module 314. The controller 312 is configured to control a control unit monitoring system (e.g., a control unit system) that includes the control unit 310. In some examples, the controller 312 may include a processor or other control circuitry configured to execute instructions of a program that controls operation of a control unit system. In these examples, the controller 312 may be configured to receive input from sensors, flow meters, or other devices included in the control unit system and control operations of devices included in the household (e.g., speakers, lights, doors, etc.). For example, the controller 312 may be configured to control operation of the network module 314 included in the control unit 310.

The network module 314 is a communication device configured to exchange communications over the network 305. The network module 314 may be a wireless communication module configured to exchange wireless communications over the network 305. For example, the network module 314 may be a wireless communication device configured to exchange communications over a wireless data channel and a wireless voice channel. In this example, the network module 314 may transmit alarm data over a wireless data channel and establish a two-way voice communication session over a wireless voice channel. The wireless communication device may include one or more of a LTE module, a GSM module, a radio modem, cellular transmission module, or any type of module configured to exchange communications in one of the following formats: LTE, GSM or GPRS, CDMA, EDGE or EGPRS, EV-DO or EVDO, UMTS, or IP.

The network module 314 also may be a wired communication module configured to exchange communications over the network 305 using a wired connection. For instance, the network module 314 may be a modem, a network interface card, or another type of network interface device. The network module 314 may be an Ethernet network card configured to enable the control unit 310 to communicate over a local area network and/or the Internet. The network module 314 also may be a voice band modem configured to enable the alarm panel to communicate over the telephone lines of Plain Old Telephone Systems (POTS).

The control unit system that includes the control unit 310 includes one or more sensors. For example, the monitoring system may include multiple sensors 320. The sensors 320 may include a camera, lock sensor, a contact sensor, a motion sensor, or any other type of sensor included in a control unit system. The sensors 320 also may include an environmental sensor, such as a temperature sensor, a water sensor, a rain sensor, a wind sensor, a light sensor, a smoke detector, a carbon monoxide detector, an air quality sensor, etc. The sensors 320 further may include a health monitoring sensor, such as a prescription bottle sensor that monitors taking of prescriptions, a blood pressure sensor, a blood sugar sensor, a bed mat configured to sense presence of liquid (e.g., bodily fluids) on the bed mat, etc. In some examples, the health-monitoring sensor can be a wearable sensor that attaches to a user in the home. The health-monitoring sensor can collect various health data, including pulse, heart rate, respiration rate, sugar or glucose level, bodily temperature, or motion data.

The sensors 320 can also include a radio-frequency identification (RFID) sensor that identifies a particular article that includes a pre-assigned RFID tag.

The control unit 310 communicates with the home automation controls 322 and a camera 330 to perform monitoring. The home automation controls 322 are connected to one or more devices that enable automation of actions in the home. For instance, the home automation controls 322 may be connected to one or more lighting systems and may be configured to control operation of the one or more lighting systems. In addition, the home automation controls 322 may be connected to one or more electronic locks at the home and may be configured to control operation of the one or more electronic locks (e.g., control Z-Wave locks using wireless communications in the Z-Wave protocol). Further, the home automation controls 322 may be connected to one or more appliances at the home and may be configured to control operation of the one or more appliances. The home automation controls 322 may include multiple modules that are each specific to the type of device being controlled in an automated manner. The home automation controls 322 may control the one or more devices based on commands received from the control unit 310. For instance, the home automation controls 322 may cause a lighting system to illuminate an area to provide a better image of the area when captured by a camera 330.

The camera 330 may be a video/photographic camera or other type of optical sensing device configured to capture images. For instance, the camera 330 may be configured to capture images of an area within a building or home monitored by the control unit 310. The camera 330 may be configured to capture single, static images of the area and also video images of the area in which multiple images of the area are captured at a relatively high frequency (e.g., thirty images per second). The camera 330 may be controlled based on commands received from the control unit 310.

The camera 330 may be triggered by several different types of techniques. For instance, a Passive Infra-Red (PIR) motion sensor may be built into the camera 330 and used to trigger the camera 330 to capture one or more images when motion is detected. The camera 330 also may include a microwave motion sensor built into the camera and used to trigger the camera 330 to capture one or more images when motion is detected. The camera 330 may have a “normally open” or “normally closed” digital input that can trigger capture of one or more images when external sensors (e.g., the sensors 320, PIR, door/window, etc.) detect motion or other events. In some implementations, the camera 330 receives a command to capture an image when external devices detect motion or another potential alarm event. The camera 330 may receive the command from the controller 312 or directly from one of the sensors 320.

In some examples, the camera 330 triggers integrated or external illuminators (e.g., Infra-Red, Z-wave controlled “white” lights, lights controlled by the home automation controls 322, etc.) to improve image quality when the scene is dark. An integrated or separate light sensor may be used to determine if illumination is desired and may result in increased image quality.

The camera 330 may be programmed with any combination of time/day schedules, system “arming state”, or other variables to determine whether images should be captured or not when triggers occur. The camera 330 may enter a low-power mode when not capturing images. In this case, the camera 330 may wake periodically to check for inbound messages from the controller 312. The camera 330 may be powered by internal, replaceable batteries if located remotely from the control unit 310. The camera 330 may employ a small solar cell to recharge the battery when light is available. Alternatively, the camera 330 may be powered by the controller's 312 power supply if the camera 330 is co-located with the controller 312.

In some implementations, the camera 330 communicates directly with the monitoring server 360 over the Internet. In these implementations, image data captured by the camera 330 does not pass through the control unit 310 and the camera 330 receives commands related to operation from the monitoring server 360.

The system 300 also includes thermostat 334 to perform dynamic environmental control at the home. thermostat 334 is configured to monitor temperature and/or energy consumption of an HVAC system associated with thermostat 334, and is further configured to provide control of environmental (e.g., temperature) settings. In some implementations, thermostat 334 can additionally or alternatively receive data relating to activity at a home and/or environmental data at a home, e.g., at various locations indoors and outdoors at the home. thermostat 334 can directly measure energy consumption of the HVAC system associated with thermostat, or can estimate energy consumption of the HVAC system associated with thermostat 334, for example, based on detected usage of one or more components of the HVAC system associated with thermostat 334. thermostat 334 can communicate temperature and/or energy monitoring information to or from the control unit 310 and can control the environmental (e.g., temperature) settings based on commands received from the control unit 310.

In some implementations, thermostat 334 is a dynamically programmable thermostat and can be integrated with the control unit 310. For example, the dynamically programmable thermostat 334 can include the control unit 310, e.g., as an internal component to the dynamically programmable thermostat 334. In addition, the control unit 310 can be a gateway device that communicates with the dynamically programmable thermostat 334. In some implementations, thermostat 334 is controlled via one or more home automation controls 322.

A module 337 is connected to one or more components of an HVAC system associated with a home, and is configured to control operation of the one or more components of the HVAC system. In some implementations, the module 337 is also configured to monitor energy consumption of the HVAC system components, for example, by directly measuring the energy consumption of the HVAC system components or by estimating the energy usage of the one or more HVAC system components based on detecting usage of components of the HVAC system. The module 337 can communicate energy monitoring information and the state of the HVAC system components to thermostat 334 and can control the one or more components of the HVAC system based on commands received from thermostat 334.

The system 300 further includes one or more integrated security devices 380. The one or more integrated security devices may include any type of device used to provide alerts based on received sensor data. For instance, the one or more control units 310 may provide one or more alerts to the one or more integrated security input/output devices 380. Additionally, the one or more control units 310 may receive one or more sensor data from the sensors 320 and determine whether to provide an alert to the one or more integrated security input/output devices 380.

The sensors 320, the home automation controls 322, the camera 330, thermostat 334, and the integrated security devices 380 may communicate with the controller 312 over communication links 324, 326, 328, 332, 338, and 384. The communication links 324, 326, 328, 332, 338, and 384 may be a wired or wireless data pathway configured to transmit signals from the sensors 320, the home automation controls 322, the camera 330, thermostat 334, and the integrated security devices 380 to the controller 312. The sensors 320, the home automation controls 322, the camera 330, thermostat 334, and the integrated security devices 380 may continuously transmit sensed values to the controller 312, periodically transmit sensed values to the controller 312, or transmit sensed values to the controller 312 in response to a change in a sensed value.

The communication links 324, 326, 328, 332, 338, and 384 may include a local network. The sensors 320, the home automation controls 322, the camera 330, thermostat 334, and the integrated security devices 380, and the controller 312 may exchange data and commands over the local network. The local network may include 802.11 “Wi-Fi” wireless Ethernet (e.g., using low-power Wi-Fi chipsets), Z-Wave, Zigbee, Bluetooth, “Homeplug” or other “Powerline” networks that operate over AC wiring, and a Category 5 (CATS) or Category 6 (CAT6) wired Ethernet network. The local network may be a mesh network constructed based on the devices connected to the mesh network.

The monitoring server 360 is an electronic device configured to provide monitoring services by exchanging electronic communications with the control unit 310, the one or more user devices 340 and 350, and the central alarm station server 370 over the network 305. For example, the monitoring server 360 may be configured to monitor events generated by the control unit 310. In this example, the monitoring server 360 may exchange electronic communications with the network module 314 included in the control unit 310 to receive information regarding events detected by the control unit 310. The monitoring server 360 also may receive information regarding events from the one or more user devices 340 and 350.

In some examples, the monitoring server 360 may route alert data received from the network module 314 or the one or more user devices 340 and 350 to the central alarm station server 370. For example, the monitoring server 360 may transmit the alert data to the central alarm station server 370 over the network 305.

The monitoring server 360 may store sensor and image data received from the monitoring system and perform analysis of sensor and image data received from the monitoring system. Based on the analysis, the monitoring server 360 may communicate with and control aspects of the control unit 310 or the one or more user devices 340 and 350.

The monitoring server 360 may provide various monitoring services to the system 300. For example, the monitoring server 360 may analyze the sensor, image, and other data to determine an activity pattern of a resident of the home monitored by the system 300. In some implementations, the monitoring server 360 may analyze the data for alarm conditions or may determine and perform actions at the home by issuing commands to one or more of the controls 322, possibly through the control unit 310.

The monitoring server 360 can be configured to provide information (e.g., activity patterns) related to one or more residents of the home monitored by the system 300. For example, one or more of the sensors 320, the home automation controls 322, the camera 330, thermostat 334, and the integrated security devices 380 can collect data related to a resident including location information (e.g., if the resident is home or is not home) and provide location information to thermostat 334.

The central alarm station server 370 is an electronic device configured to provide alarm monitoring service by exchanging communications with the control unit 310, the one or more user devices 340 and 350, and the monitoring server 360 over the network 305. For example, the central alarm station server 370 may be configured to monitor alerting events generated by the control unit 310. In this example, the central alarm station server 370 may exchange communications with the network module 314 included in the control unit 310 to receive information regarding alerting events detected by the control unit 310. The central alarm station server 370 also may receive information regarding alerting events from the one or more user devices 340 and 350 and/or the monitoring server 360.

The central alarm station server 370 is connected to multiple terminals 372 and 374. The terminals 372 and 374 may be used by operators to process alerting events. For example, the central alarm station server 370 may route alerting data to the terminals 372 and 374 to enable an operator to process the alerting data. The terminals 372 and 374 may include general-purpose computers (e.g., desktop personal computers, workstations, or laptop computers) that are configured to receive alerting data from a server in the central alarm station server 370 and render a display of information based on the alerting data. For instance, the controller 312 may control the network module 314 to transmit, to the central alarm station server 370, alerting data indicating that a sensor 320 detected motion from a motion sensor via the sensors 320. The central alarm station server 370 may receive the alerting data and route the alerting data to the terminal 372 for processing by an operator associated with the terminal 372. The terminal 372 may render a display to the operator that includes information associated with the alerting event (e.g., the lock sensor data, the motion sensor data, the contact sensor data, etc.) and the operator may handle the alerting event based on the displayed information.

In some implementations, the terminals 372 and 374 may be mobile devices or devices designed for a specific function. Although FIG. 3 illustrates two terminals for brevity, actual implementations may include more (and, perhaps, many more) terminals.

The one or more authorized user devices 340 and 350 are devices that host and display user interfaces. For instance, the user device 340 is a mobile device that hosts or runs one or more native applications (e.g., the home monitoring application 342). The user device 340 may be a cellular phone or a non-cellular locally networked device with a display. The user device 340 may include a cell phone, a smart phone, a tablet PC, a personal digital assistant (“PDA”), or any other portable device configured to communicate over a network and display information. For example, implementations may also include Blackberry-type devices (e.g., as provided by Research in Motion), electronic organizers, iPhone-type devices (e.g., as provided by Apple), iPod devices (e.g., as provided by Apple) or other portable music players, other communication devices, and handheld or portable electronic devices for gaming, communications, and/or data organization. The user device 340 may perform functions unrelated to the monitoring system, such as placing personal telephone calls, playing music, playing video, displaying pictures, browsing the Internet, maintaining an electronic calendar, etc.

The user device 340 includes a home monitoring application 342. The home monitoring application 342 refers to a software/firmware program running on the corresponding mobile device that enables the user interface and features described throughout. The user device 340 may load or install the home monitoring application 342 based on data received over a network or data received from local media. The home monitoring application 342 runs on mobile devices platforms, such as iPhone, iPod touch, Blackberry, Google Android, Windows Mobile, etc. The home monitoring application 342 enables the user device 340 to receive and process image and sensor data from the monitoring system.

The user device 340 may be a general-purpose computer (e.g., a desktop personal computer, a workstation, or a laptop computer) that is configured to communicate with the monitoring server 360 and/or the control unit 310 over the network 305. The user device 340 may be configured to display a smart home user interface 352 that is generated by the user device 340 or generated by the monitoring server 360. For example, the user device 340 may be configured to display a user interface (e.g., a web page) provided by the monitoring server 360 that enables a user to perceive images captured by the camera 330 and/or reports related to the monitoring system. Although FIG. 3 illustrates two user devices for brevity, actual implementations may include more (and, perhaps, many more) or fewer user devices.

In some implementations, the one or more user devices 340 and 350 communicate with and receive monitoring system data from the control unit 310 using the communication link 338. For instance, the one or more user devices 340 and 350 may communicate with the control unit 310 using various local wireless protocols such as Wi-Fi, Bluetooth, Z-wave, Zigbee, HomePlug (ethernet over power line), or wired protocols such as Ethernet and USB, to connect the one or more user devices 340 and 350 to local security and automation equipment. The one or more user devices 340 and 350 may connect locally to the monitoring system and its sensors and other devices. The local connection may improve the speed of status and control communications because communicating through the network 305 with a remote server (e.g., the monitoring server 360) may be significantly slower.

Although the one or more user devices 340 and 350 are shown as communicating with the control unit 310, the one or more user devices 340 and 350 may communicate directly with the sensors and other devices controlled by the control unit 310. In some implementations, the one or more user devices 340 and 350 replace the control unit 310 and perform the functions of the control unit 310 for local monitoring and long range/offsite communication.

In other implementations, the one or more user devices 340 and 350 receive monitoring system data captured by the control unit 310 through the network 305. The one or more user devices 340, 350 may receive the data from the control unit 310 through the network 305 or the monitoring server 360 may relay data received from the control unit 310 to the one or more user devices 340 and 350 through the network 305. In this regard, the monitoring server 360 may facilitate communication between the one or more user devices 340 and 350 and the monitoring system.

In some implementations, the one or more user devices 340 and 350 may be configured to switch whether the one or more user devices 340 and 350 communicate with the control unit 310 directly (e.g., through link 338) or through the monitoring server 360 (e.g., through network 305) based on a location of the one or more user devices 340 and 350. For instance, when the one or more user devices 340 and 350 are located close to the control unit 310 and in range to communicate directly with the control unit 310, the one or more user devices 340 and 350 use direct communication. When the one or more user devices 340 and 350 are located far from the control unit 310 and not in range to communicate directly with the control unit 310, the one or more user devices 340 and 350 use communication through the monitoring server 360.

Although the one or more user devices 340 and 350 are shown as being connected to the network 305, in some implementations, the one or more user devices 340 and 350 are not connected to the network 305. In these implementations, the one or more user devices 340 and 350 communicate directly with one or more of the monitoring system components and no network (e.g., Internet) connection or reliance on remote servers is needed.

In some implementations, the one or more user devices 340 and 350 are used in conjunction with only local sensors and/or local devices in a house. In these implementations, the system 300 includes the one or more user devices 340 and 350, the sensors 320, the home automation controls 322, the camera 330, and robotic devices 390. The one or more user devices 340 and 350 receive data directly from the sensors 320, the home automation controls 322, the camera 330, and the robotic devices 390, and sends data directly to the sensors 320, the home automation controls 322, the camera 330, and the robotic devices 390. The one or more user devices 340, 350 provide the appropriate interfaces/processing to provide visual surveillance and reporting.

In other implementations, the system 300 further includes network 305 and the sensors 320, the home automation controls 322, the camera 330, thermostat 334, and the robotic devices 390, and are configured to communicate sensor and image data to the one or more user devices 340 and 350 over network 305 (e.g., the Internet, cellular network, etc.). In yet another implementation, the sensors 320, the home automation controls 322, the camera 330, thermostat 334, and the robotic devices 390 (or a component, such as a bridge/router) are intelligent enough to change the communication pathway from a direct local pathway when the one or more user devices 340 and 350 are in close physical proximity to the sensors 320, the home automation controls 322, the camera 330, thermostat 334, and the robotic devices 390 to a pathway over network 305 when the one or more user devices 340 and 350 are farther from the sensors 320, the home automation controls 322, the camera 330, thermostat 334, and the robotic devices 390.

In some examples, the system leverages GPS information from the one or more user devices 340 and 350 to determine whether the one or more user devices 340 and 350 are close enough to the sensors 320, the home automation controls 322, the camera 330, thermostat 334, and the robotic devices 390 to use the direct local pathway or whether the one or more user devices 340 and 350 are far enough from the sensors 320, the home automation controls 322, the camera 330, thermostat 334, and the robotic devices 390 that the pathway over network 305 is required.

In other examples, the system leverages status communications (e.g., pinging) between the one or more user devices 340 and 350 and the sensors 320, the home automation controls 322, the camera 330, thermostat 334, and the robotic devices 390 to determine whether communication using the direct local pathway is possible. If communication using the direct local pathway is possible, the one or more user devices 340 and 350 communicate with the sensors 320, the home automation controls 322, the camera 330, thermostat 334, and the robotic devices 390 using the direct local pathway. If communication using the direct local pathway is not possible, the one or more user devices 340 and 350 communicate with the sensors 320, the home automation controls 322, the camera 330, thermostat 334, and the robotic devices 390 using the pathway over network 305.

In some implementations, the system 300 provides end users with access to images captured by the camera 330 to aid in decision making. The system 300 may transmit the images captured by the camera 330 over a wireless WAN network to the user devices 340 and 350. Because transmission over a wireless WAN network may be relatively expensive, the system 300 can use several techniques to reduce costs while providing access to significant levels of useful visual information (e.g., compressing data, down-sampling data, sending data only over inexpensive LAN connections, or other techniques).

In some implementations, a state of the monitoring system and other events sensed by the monitoring system may be used to enable/disable video/image recording devices (e.g., the camera 330). In these implementations, the camera 330 may be set to capture images on a periodic basis when the alarm system is armed in an “away” state, but set not to capture images when the alarm system is armed in a “home” state or disarmed. In addition, the camera 330 may be triggered to begin capturing images when the alarm system detects an event, such as an alarm event, a door-opening event for a door that leads to an area within a field of view of the camera 330, or motion in the area within the field of view of the camera 330. In other implementations, the camera 330 may capture images continuously, but the captured images may be stored or transmitted over a network when needed.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device.

Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

1. A computer-implemented method comprising:
obtaining a first image of a person within a first threshold distance of a property;
predicting, using the first image of the person, a task flow including a sequence of activities to be performed by the person;
obtaining a second image of the person within a second threshold distance of the property;
determining, using the second image, that activities performed by the person do not match the task flow; and
in response to determining that the activities performed by the person do not match the predicted task flow, performing one or more actions at the property.

2. The method of claim 1, wherein predicting the task flow comprises:
determining, using one or more images of the person, that a person crossed a virtual line for the property; and
in response to determining that the person crossed the virtual line for the property, predicting the task flow including the sequence of activities to be performed by the person.

3. The method of claim 1, wherein predicting the task flow comprises:
determining, using one or more images of the person, whether a time period satisfies a time period threshold; and
in response to determining that the time period satisfies the time period threshold, predicting the task flow including the sequence of activities to be performed by the person.

4. The method of claim 1, wherein predicting the task flow comprises:
determining, using one or more images of the person, whether a time period after which the person completed a task satisfies a time period threshold; and
in response to determining that the time period after which the person completed the task satisfies the time period threshold, predicting the task flow including the sequence of activities to be performed by the person.

5. The method of claim 1, wherein predicting the task flow comprises:
determining, using one or more images of the person and an eye tracking process, an object at which the person is likely looking; and
predicting, using data for the object at which the person is likely looking, the task flow including the sequence of activities to be performed by the person.

6. The method of claim 1, wherein predicting the task flow comprises:
determining, using one or more images of the person, one or more tasks performed at least a threshold amount by the person; and
selecting, from the one or more tasks performed at least the threshold amount by the person, a most likely task flow for the person.

7. The method of claim 1, wherein predicting the task flow comprises:
determining, using one or more images of the person, a predicted visit type for the person; and
selecting, from a database that includes data for a plurality tasks and using the predicted visit type for the person, a most likely task flow for the person.

8. The method of claim 1, wherein predicting the task flow comprises:
determining, using one or more images of the person and one or more inputs, one or more tasks performed at least a threshold amount by the person; and
selecting, from the one or more tasks performed at least the threshold amount by the person, a most likely task flow for the person.

9. The method of claim 1, wherein predicting the task flow comprises:
determining, using one or more images of the person and sensor data from the property, one or more tasks performed at least a threshold amount by the person; and
selecting, from the one or more tasks performed at least a threshold amount by the person, a most likely task flow for the person.

10. The method of claim 1, wherein performing the one or more actions at the property comprises providing, to a signaling device physically located at the property, an instruction to cause the signaling device to present an alert to the person about at least one activity from the sequence of activities for the task flow.

11. A system comprising one or more computers and one or more storage devices on which are stored instructions that are operable, when executed by the one or more computers, to cause the one or more computers to perform operations comprising:
obtaining a first image of a person within a first threshold distance of a property;
predicting, using the first image of the person, a task flow including a sequence of activities to be performed by the person;
obtaining a second image of the person within a second threshold distance of the property;
determining, using the second image, that activities performed by the person do not match the task flow; and
in response to determining that the activities performed by the person do not match the predicted task flow, performing one or more actions at the property.

12. The system of claim 11, wherein predicting the task flow comprises:
determining, using one or more images of the person, that a person crossed a virtual line for the property; and
in response to determining that the person crossed the virtual line for the property, predicting the task flow including the sequence of activities to be performed by the person.

13. The system of claim 11, wherein predicting the task flow comprises:
determining, using one or more images of the person, whether a time period satisfies a time period threshold; and
in response to determining that the time period satisfies the time period threshold, predicting the task flow including the sequence of activities to be performed by the person.

14. The system of claim 11, wherein predicting the task flow comprises:
determining, using one or more images of the person, whether a time period after which the person completed a task satisfies a time period threshold; and
in response to determining that the time period after which the person completed the task satisfies the time period threshold, predicting the task flow including the sequence of activities to be performed by the person.

15. The system of claim 11, wherein predicting the task flow comprises:
determining, using one or more images of the person and an eye tracking process, an object at which the person is likely looking; and
predicting, using data for the object at which the person is likely looking, the task flow including the sequence of activities to be performed by the person.

16. The system of claim 11, wherein predicting the task flow comprises:
determining, using one or more images of the person, one or more tasks performed at least a threshold amount by the person; and
selecting, from the one or more tasks performed at least the threshold amount by the person, a most likely task flow for the person.

17. The system of claim 11, wherein predicting the task flow comprises:
determining, using one or more images of the person, a predicted visit type for the person; and
selecting, from a database that includes data for a plurality tasks and using the predicted visit type for the person, a most likely task flow for the person.

18. The system of claim 11, wherein predicting the task flow comprises:
determining, using one or more images of the person and one or more inputs, one or more tasks performed at least a threshold amount by the person; and
selecting, from the one or more tasks performed at least the threshold amount by the person, a most likely task flow for the person.

19. The system of claim 11, wherein predicting the task flow comprises:
determining, using one or more images of the person and sensor data from the property, one or more tasks performed at least a threshold amount by the person; and
selecting, from the one or more tasks performed at least a threshold amount by the person, a most likely task flow for the person.

20. One or more non-transitory computer storage media encoded with instructions that, when executed by one or more computers, cause the one or more computers to perform operations comprising:
obtaining a first image of a person within a first threshold distance of a property;
predicting, using the first image of the person, a task flow including a sequence of activities to be performed by the person;
obtaining a second image of the person within a second threshold distance of the property;
determining, using the second image, that activities performed by the person do not match the task flow; and
in response to determining that the activities performed by the person do not match the predicted task flow, performing one or more actions at the property.
